(19) United States
(12) Patent Application Publication
(10) Pub. No.: US 2006/0178056 A1
(43) Pub. Date: Aug. 10, 2006

(54) Plastic product and its mold and applicable product thereof

(75) Inventor: Daizo Kotaki, Ashikaga-shi (JP)

Correspondence Address: PITNEY HARDIN LLP, 7 TIMES SQUARE, NEW YORK, NY, 10036-7311, US

(73) Assignee: DAISAN CO., LTD., Tochigi (JP)

(21) Appl. No.: 11/317,864

(22) Filed: Dec. 23, 2005

(30) Foreign Application Priority Data
Dec. 24, 2004 (JP) JP2004-382834
Jul. 25, 2005 (JP) JP2005-239142

(51) Int. Cl. H01R 24/00

(52) U.S. Cl. 439/660

(57) ABSTRACT

A plastic product disclosed herein devises weight reduction by structuring the principal parts of the merchandise with plastic material, and at the same time, provides a structure that rivals the strength of iron in shelve boards and brackets or any other applications, and a structure for the mold thereof. The plastic product is made of plastic board which utilizes symmetrical latticed ribs on both sides of the board, at the same time, the latticed ribs being formed slantwise to the lengthwise direction of the board, thereby to prevent the warping of the board and reinforce its strength

### TECHNICAL FIELD

This invention provides a plastic board with satisfactory strength, heretofore considered to be difficult. Further, as specific products, utilization is possible in transport pallets and desks, countertops, and the like, in construction materials where strength is needed, but in this invention, a board is provided which is most suitable as a bottom board or a slide board in automatic vending machines and showcases in particular, that display and sell beverages in containers such as cans and bottles. Furthermore, this relates to dividers and bracket structures and molds for molding that are used in conjunction therewith.

### PRIOR ART

One example of industrial applications of such plastic board is application to merchandise shelves. At retail food sales locations in department stores, supermarkets, convenience stores and the like, many varieties of canned beverages, bottled beverages, beverages in plastic bottles, etc. are sold. The merchandise is displayed on merchandise shelves. These merchandise shelves are constructed of shelf boards, supports, brackets, etc., but metal is always used in the parts. The reason for this is that the items are relatively heavy in weight, and adequate strength must be maintained when they are placed on display.

However, because the entirety is metal, the weight of the shelf itself becomes quite heavy, and at the same time that there are difficulties in portability, there is the need to paint the sheet metal, so there is high cost.

Items such as different kinds of beverages are generally separated into the respective varieties in the refrigerated showcase and arranged from the front to the back of the display shelf. The customer looks at the display shelf, selects the desired varieties, and purchases the items in order from the very front row. On the other hand, the store clerks move the merchandise toward the front when there are too few items of a particular kind, and replenish the items from the back. The stock is replenished from the back, because there is the need to sell the merchandise on initial display first, and at the same time, when the merchandise is displayed in a refrigerated chamber, it is necessary to provide enough time for the items to cool before the customer's purchase.

As the slide board for sliding the merchandise to the front consistently, a board with rollers, when it is new, has outstanding slide performance. However, the slide performance deteriorates with passage of time due to water condensation and material property changes in the showcase. Additionally, there were problems from the cost standpoint due to the cost of materials and the number of steps involved in the assembly.

Furthermore, other simpler types of slide boards now in use comprise painted iron sheets and those provided with uneven surfaces, but there were problems with slide performance due to peeling of the paint and the large friction coefficient of the uneven surface. Further, in supermarkets, for example, general display shelves on which boxed candies and packaged foods are placed are installed to slant downwards toward the front at an angle of about 5 to 20 degrees to enable easier access to the merchandise. In this situation, there is some sliding in the forward direction from the weight of the item itself, but the shelf is merely a flat board, so there was no guarantee that when the customer took the item in the front, the item in the back would always slide to the front. In supermarkets recently, when loss leaders are first placed on sale, a large number of merchandise is very often placed on display at the same time.

In such a case, situations arise where there is the need to avoid congestion by having the customer take the items from the front as much as possible, and the need to replenish the merchandise from the back of the shelf so that there is no lack of display merchandise. Moreover, because of reduction in labor costs, the situation occurs where there is no person available to specifically concentrate on keeping the display of merchandise in good-looking order.

Another example of applications of the above mentioned plastic board is a bracket for supporting merchandise shelves. The bracket supports the metal shelf and merchandise having relatively heavy weight such as beverage containers, so only those made of metal were available up to now. When these were replaced with plastic, the same strength as iron was required; ultimately, there was no plastic material that exceeded the performance of iron. Still another example of applications is a transport pallet or desk or belt conveyor which experiences similar problems with mechanical strength when being replaced with plastic material.

The biggest problem of the conventional merchandise shelf was weight reduction. When attempts were made to use plastic to reduce weight, there was the problem of strength.

### SUMMARY OF THE INVENTION

Therefore, the present invention devises weight reduction by structuring the principal parts of the merchandise with plastic material, and at the same time, provides a structure that rivals the strength of iron in shelve boards and brackets or any other applications, and a structure for the mold thereof.

In one aspect of the present invention, one of these problems are solved by providing a plastic board which comprises symmetrical latticed ribs on both sides of the board, at the same time, the latticed ribs being formed slantwise to the lengthwise direction of the board, thereby to prevent the warping of the board and reinforce its strength.

In another aspect of the present invention, the above mentioned problems are solved by providing a plastic board which comprises symmetrical latticed ribs on both sides of the board, moreover, the latticed ribs forming a continuous V-shape as continuous V-shaped ribs formed slantwise to the lengthwise direction of the board, and at the same time, the continuous V-shaped ribs on one side of the board being staggered lengthwise to the continuous V-shaped ribs on the other side to prevent the warping of the board and reinforce its strength.

In still another aspect of the present invention, the above mentioned problems are solved by providing a plastic board which comprises symmetrical latticed ribs on both sides of the board, the latticed ribs being formed slantwise to the lengthwise direction of the board, said plastic board further including guide channels provided for holding molten resin injected from injection molder on both sides of the board guide channels and ejecting the molten resin by pressure.

According to one of those aspects of the present invention, the board can be constructed of plastic, so weight reduction is possible in comparison to using the conventional metal materials such as iron. Further, there is increase in productivity because processes such as painting the sheet metal are eliminated. In addition, although it is plastic material, because the structure has ribs formed slantwise in the lengthwise direction of the product, the strength is equal to that of the conventional board made of iron; the increase in portability of the product is an advantage. Furthermore, because guide channels are adopted, there is exceptionally smooth flow of the molten resin in the mold in spite of the low pressure molding.

It is possible to manufacture a large-size plastic board by molding as one entity, and at the same time, the occurrence of fins is suppressed due to the increase in fluidity. Such major effects are obtained.

As an example of applications of the present invention, the merchandise display shelf is constructed with plastic shelf board, weight reduction is possible in comparison to using the conventional metal materials such as iron. At the same time, because the structure has ribs formed slantwise in the lengthwise direction of the product, the strength is equal to that of the conventional flat board made of iron; the increase in the portability of the product is an advantage. Although the present invention has a variety of applications, the same advantages and effects with weight reduction and comparable mechanical strength may be expected regardless of the area of such applications.

In still another aspect of the present invention, a injection molding mold is provided for molding the plastic board, which comprises a top mold and a bottom mold respectively comprising the concave sections for forming the board, and bottoms of the concave sections for the board being provided with latticed rib grooves slantwise to the lengthwise direction of the board to prevent the warping of a molded article and reinforce its strength.

The injection-molding mold is provided that has the structure having good mold release in the molding of a flat board, moreover, does not result in shrinkage or warping, because of the latticed rib grooves, guide channel grooves, and the symmetrical groove placement in the mold.

### BRIEF DESCRIPTION OF THE DRAWINGS

The above objects, and other features and advantages of the present invention will become more apparent after reading the following detailed description when taken in conjunction with the drawings, in which:

FIG. 1 is a top view of one example of the board of the present invention.

FIG. 2 is an oblique view of another example of the board of this invention.

FIG. 3 is an A-A′ cross-sectional view of one example of the board of this invention.

FIG. 4 is a B-B′ cross-sectional view of another example of the board of this invention.

FIG. 5 is a cross-sectional view of the mold for molding the board of this invention.

FIG. 6 is an oblique view of the merchandise display shelf of this invention.

FIG. 7 is a side view of the bracket of this invention.

FIG. 8 is a C-C′ cross-sectional view of the bracket of this invention.

FIG. 9 is a D-D′ cross-sectional view of the bracket of this invention.

FIG. 10 is a side view of another example of the bracket of this invention.

FIG. 11 is an oblique view of another example of the bracket of this invention.

FIG. 12 is an oblique view of another example of the bracket of this invention.

FIG. 13 is a side view of another example of the bracket of this invention.

FIG. 14 is on oblique view of the support of this invention.

FIGS. 15a and 15b are an elevational view and a side view of the attachment board used in the merchandise display shelf of this invention.

### DETAILED DESCRIPTION OF EMBODIMENTS

This invention is explained in concrete terms below by citing practical examples, but the range of this invention is not limited to these examples. Further, in the title and the explanation of this invention, the term “display shelf” in the explanation is assumed to represent units for the display and sales of beverages in containers such as cans, bottles, etc., including showcases and automatic vending machines, heated storage units and refrigerators and the like. These kinds of showcases have a slide board comprising a flat board with a slanted face that is slanted downward to the door side in the direction of removal of the containers; the structure is such that containers such as cans and bottles that are placed on this slide board slide down and are removed in order.

In the usual structure, slide boards are generally placed on top of the shelves already located within the showcase.

### EXAMPLES

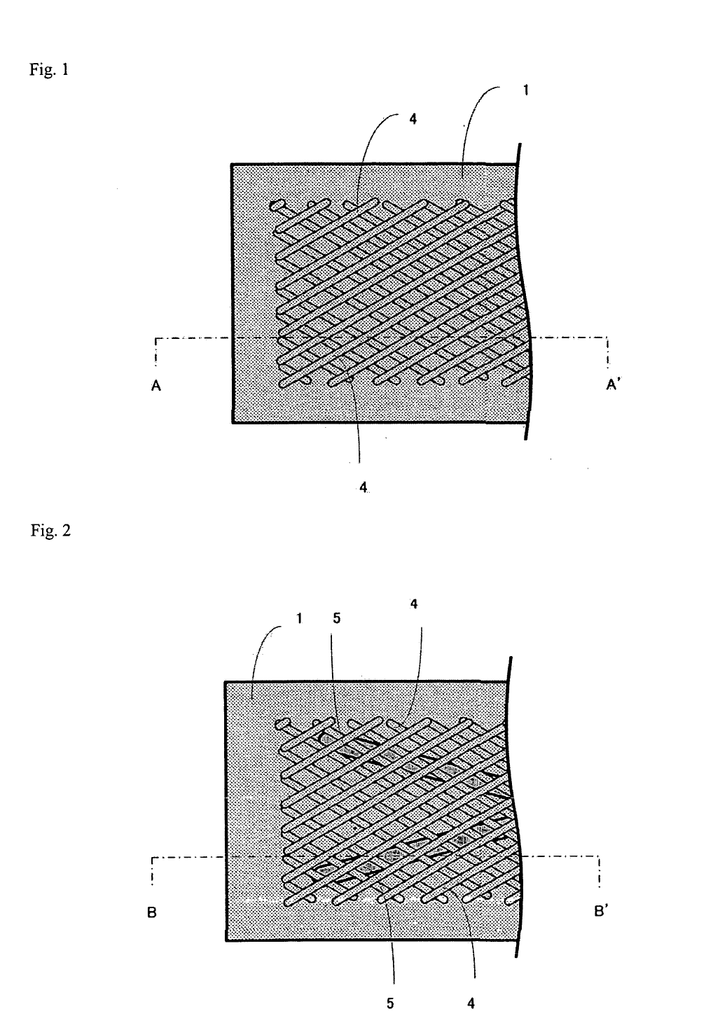

Details are explained below on the basis of practical examples. FIG. 1 shows the flat board of this invention; 1 is the entire flat board. On top of this flat board 1, the latticed ribs 4 are formed in the lengthwise direction of flat board 1 in a diamond shape. The latticed ribs 4 formed slantwise are effective in preventing warping and reinforcing strength. These latticed ribs 4 are formed along the lengthwise direction of the flat board 1, so the flow of the molten resin is also along the lengthwise direction of flat board 1. Because of this, there are no load changes at the time of molding; moreover, because the formation occurs along the so-called grain, warping occurs with difficulty. In tests by the applicants, results were obtained results that with the form of flat board 1, warping was more difficult than with latticed ribs formed as squares or rectangles.

FIG. 2 shows another practical example of this invention; guide 5 is provided on the same face as the latticed ribs 4 of flat board 1. This guide 5 is there, at the time of injection molding, as ribs having wider diameter than the latticed ribs 4, to store the molten material flowing through the gate in the wide-diameter ribs at constant pressure before exerting pressure for ejection into the connecting narrow latticed ribs 4. This action makes the molten material flow to the ends of the latticed ribs 4, and enables the molding of the latticed ribs by low-pressure molding.

Ideally, these form a radial shape from about the center of flat board 1; moreover, are arranged so they do not reach the edge of flat board 1.

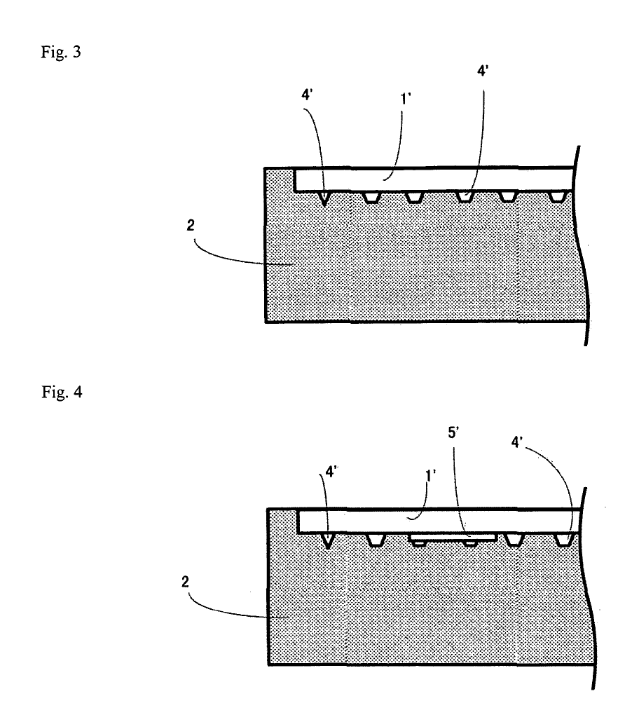

FIG. 3 shows the mold for forming the molded article of FIG. 1, and shows the A-A′ cross-sectional view. The acute-angled groove carved into the face of mold 2 is the part where the latticed rib grooves 4′ become one groove; the trapezoidal grooves carved into the face of mold 2 show the cross-section of the intersection with latticed ribs 4′.

FIG. 4 shows the mold for forming the molded article of FIG. 2, and shows the B-B′ cross-sectional view. The acute-angled groove carved into the face of mold 2 is the part where the latticed rib grooves 4′ become one groove; the trapezoidal grooves carved into the face of mold 2 show the cross-section of the intersection with the latticed ribs 4′. Furthermore, the groove in the center section shows the cross-section of the intersecting part of the latticed rib groove 4′ and the guide groove 5′.

The guide groove 5′ is carved more shallowly than the groove for latticed rib groove 4′. However, depending on how flat board 1 is used, it can be carved out deeper than the groove for latticed rib groove 4′.

In this practical example, the shelf board is for the placement of the merchandise, so in the example that is shown, it is carved more shallowly than for latticed rib groove 4′ so as not to be a hindrance at the time of placement. Because this guide groove 5′ is there, the molten resin from the molder flows vigorously in the mold, and the phenomenon such as shrinkage at the time of molding the board structure does not occur.

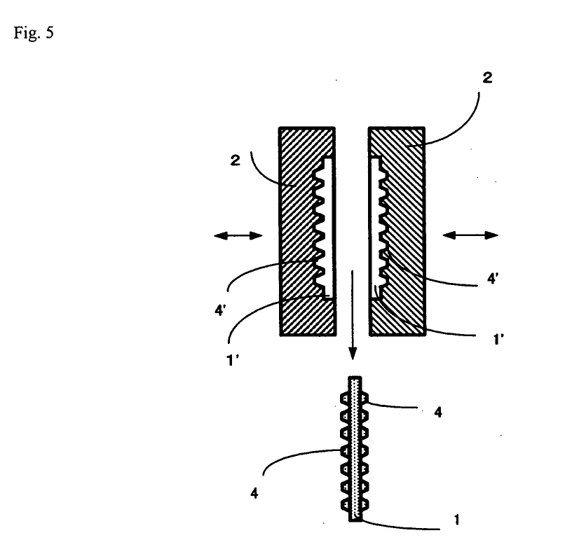

FIG. 5 is the cross-sectional view of mold 2 for molding the board of this invention. In the top mold and the bottom mold respectively, the concave board section 1′ and the latticed rib grooves 4′ for forming flat board 1 are formed symmetrically.

In one practical example of this invention where both faces are carved, when equal loads are exerted on the top mold and the bottom mold for mold release after the injection of the molten resin, because the reciprocal mold faces have the same shape, the same degree of load is exerted at the time of mold release. Because of this, the mold release operation can be done with the same timing; the molded article, flat board 1, can be released from the mold simply without using the extrusion pin. Consequently, there is no need for an extrusion pinhole for use by the extrusion pin as in the case of the usual mold release. The advantages include much easier mold manufacture, moreover, no deformation of the molded article by the extrusion action, and furthermore, an increase in the number of shots.

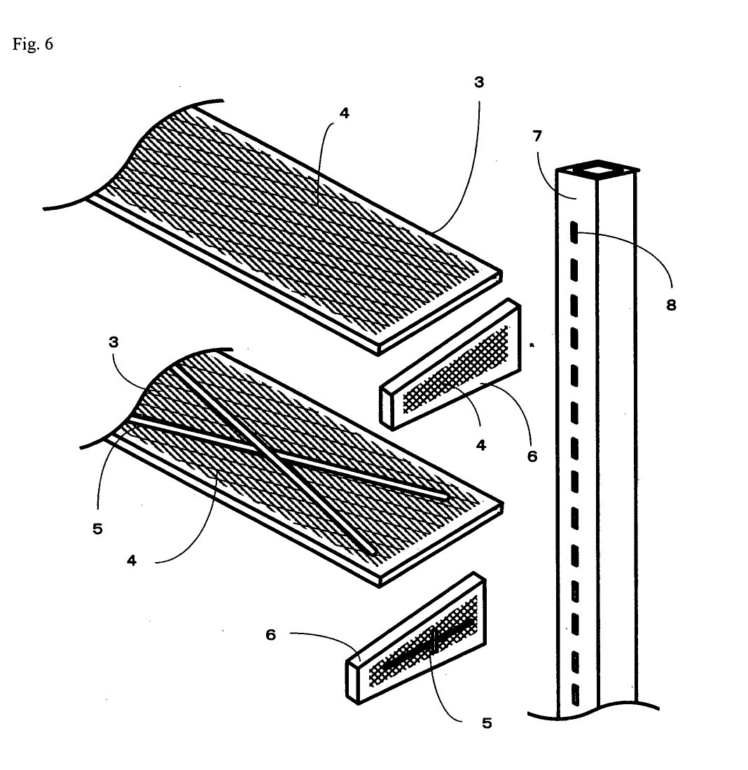

FIG. 6 is the oblique view of the entire merchandise display shelf that utilizes the molded article of this invention, and shows the top level and the bottom level sections. A multiplicity of holes 8 have been formed on support 7; at the top level, bracket 6 having the latticed ribs 4 is caught on these holes 8. Shelf 3 having the latticed ribs 4 is placed on top of this bracket 6. The bottom level has structure identical to the top level, but guides 5 have been formed respectively on bracket 6 and shelf 3.

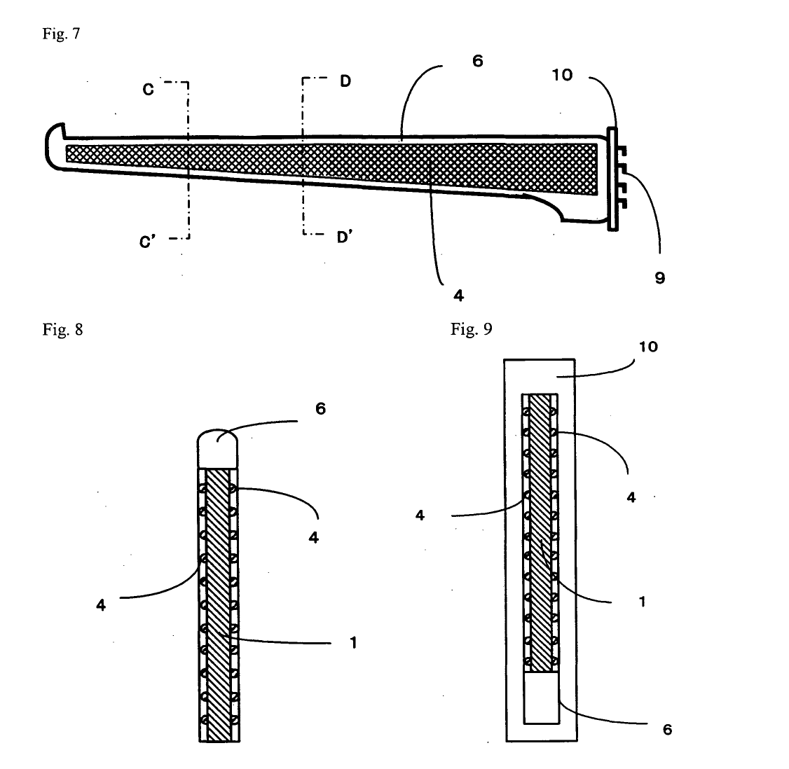

FIG. 7 is the side view of the bracket 6 of this invention. At the tapered front edge, a protrusion has been formed for catching on shelf 3; latticed ribs 4 are provided on the board section. At the base of bracket 6, collar 10 that adheres closely to one face of support 7 is provided with its length in the vertical direction; furthermore, a multiplicity of hooks 9 has been provided for catching on support 7. Bracket 6 is fixed firmly on the support by the mutual action of the hooks 9 and the collar 10.

FIG. 8 is the C-C′ cross-sectional view of FIG. 7, and is the cross-section in the forward edge direction of bracket 6. The top section is the protrusion; the hatching in the middle is flat board 1; the protruded section on top of this flat board 1 is the cross-section of latticed ribs 4.

FIG. 9 is the D-D′ cross-sectional view of FIG. 7, and is the cross-section in the base direction of bracket 6. The outer section is collar 10; the hatching in the middle is flat board 1; the protruded section at the top of this flat board 1 is the cross-section of latticed ribs 4.

FIG. 10 is the partial enlarged view of bracket 6, and shows the diamond-shaped latticed ribs 4 and collar 10 and hook 9. The special feature in this figure is the reinforcement rib for hook 9. In hook 9 shown at the top, a thin long vertical rib 11 for hook use is provided in the vertical direction on the side catching on the support.

In hook 9 shown at the bottom, a thin long top rib 12 for hook use is provided in the horizontal direction at the top of the hook. The strength of the plastic hook 9 is increased by means of these reinforcement ribs. In tests by the applicants, depending on the weight of the merchandise, there was about a twofold difference between providing and not providing the reinforcement ribs.

Furthermore, a curvature is provided to increase the strength of hook 9, at the part where hook 9 connects to support 7. It is known that in general, the strength of the part is increased when there is a curvature; this theory is applied here.

FIG. 11 is the oblique view as seen from the hook 9 side; the hook 9 has a tapered shape that becomes narrower toward the lower part. The strength of hook 9 is increased thereby, but in addition, it is further strengthened by the addition of vertical rib 11 for hook use.

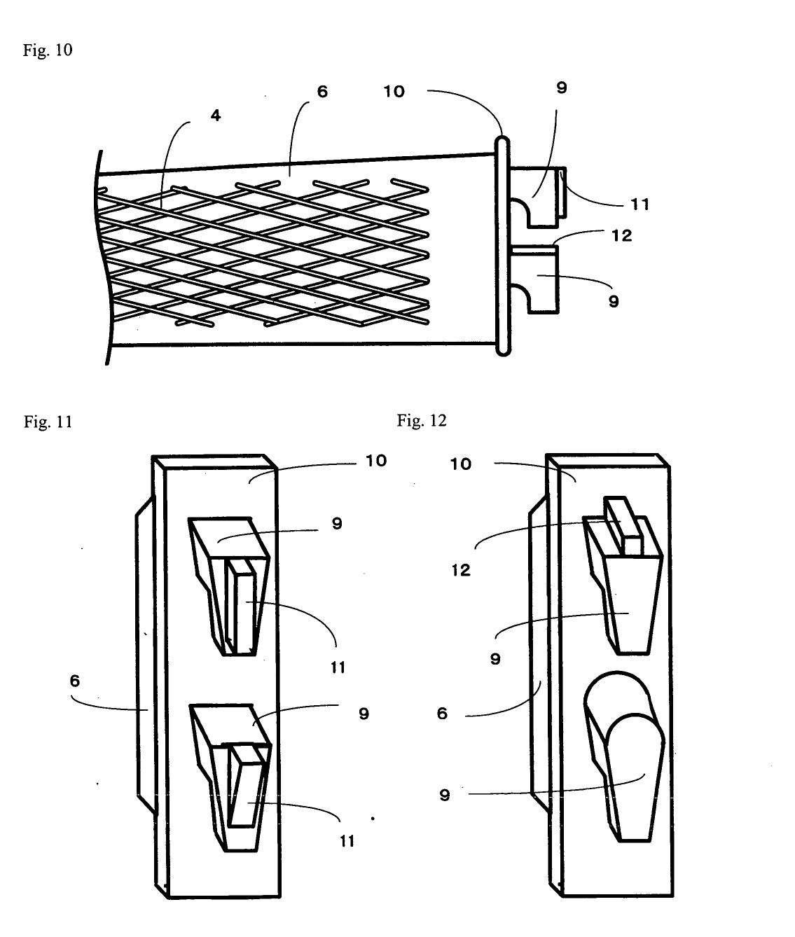

FIG. 12 also shows the increase in the strength of hook 9 by providing the taper as in FIG. 11. The figure of hook 9 at the top shows that rib 12 is provided at the top. In hook 9 at the bottom, the strength is increased by providing a curvature at the top of the hook.

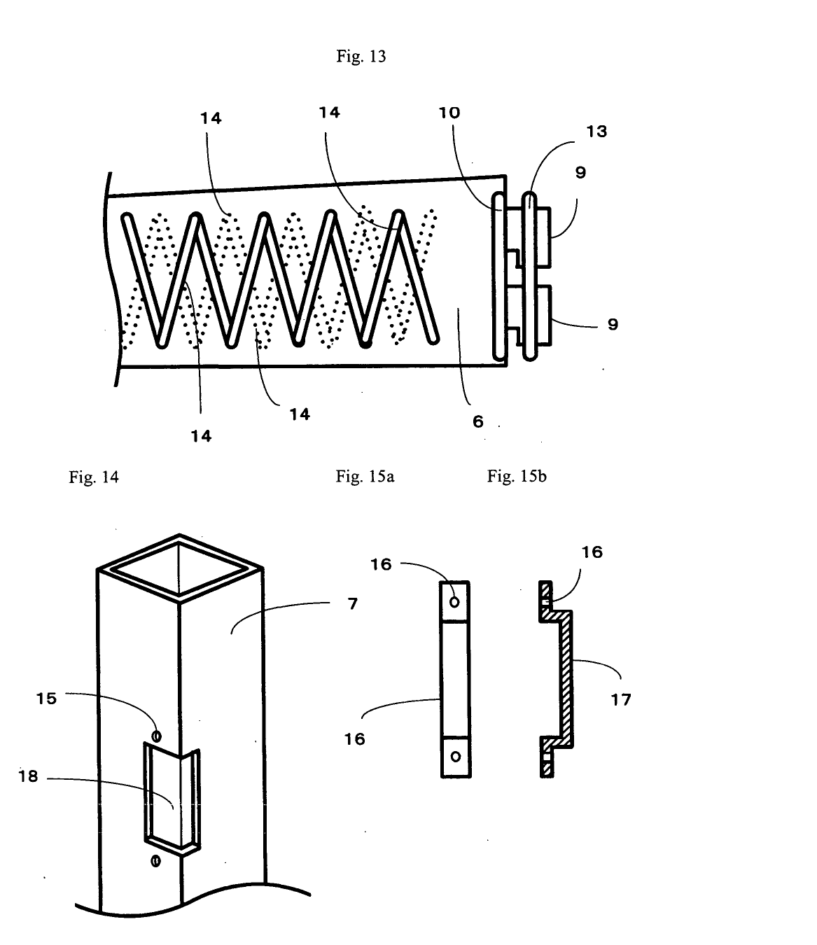

FIG. 13 shows another practical example of bracket 6; there are two special features. One is that the latticed ribs 4 form a continuous V-shape; the other is that the reinforcement collar 13 is provided parallel to the collar 10 of bracket 6.

To explain the continuous V-shaped ribs 14 having the continuous V-shape, the continuous V-shaped ribs 14 are provided on one face of bracket 6. Together with this, the continuous V-shaped ribs 14 are also provided on the other face of bracket 6; in addition, the continuous V-shaped ribs 14 on both faces are formed by mutually staggering in the lengthwise direction. By means of this staggered form, the open parts of the continuous V-shaped ribs 14 on one face have the continuous V-shaped ribs 14 interposed on the back face; this form prevents the warping of bracket 6, and at the same time, reinforces its strength.

To explain the reinforcement collar 13, by providing the reinforcement collar 13 of almost the same shape parallel to the original collar 10, when bracket 6 is attached to the support, one face of the support 7 having the cutout section 15 as shown in FIG. 14 is inserted between the collar 10 and the reinforcement collar 13 during the attachment. The collar 10 and the reinforcement collar 13 are inserted by sliding horizontally into the cutout hole 18 comprising the opening in the support 7. As the result, the hook 9 connects with the support 7, and at the same time, the reinforcement collar 13 also adheres closely to the face of support 7 to provide contact to the face, so the strength is greatly increased. In this case, the hook 9 at the top is not in contact with the cutout section 15 at the bottom and remains free, but there are no problems because the hook 9 at the bottom is in contact with the bottom of the cutout section 15.

FIG. 15 shows the attachment board 17 that enables the reinforcement collar 13 to be held in place on support 7. In order to further ensure that the connection between the bracket 6 and the support 7 is secure for the collar 10 and the reinforcement collar 13, attached to one face of the support 7 by insertion, the reinforcement collar 13 is held in place from the top and pushed into the support 7. Screw holes 16 are provided at both ends of the attachment board 17 for screw attachment; the attachment board 17 is fixed in place by screws through the attachment holes 15 in FIG. 14. The center section of the attachment board 17 has a rectangular U-shape to hold down the reinforcement collar 13.

With this structure, even though this is a plastic merchandise display shelf, its strength and durability are equal to those of the metal merchandise display shelf. Because of the weight reduction possible, there are more advantages than not, such as the portability and the reduction in the number of processes.

The inventor of this application patented his new plastic filters, its injection molding die and production method as U.S. Pat. No. 5,423,893 (issued Jun. 13, 1995) and U.S. Pat. No. 5,650,181 (issued Jul. 22, 1997), of which disclosures are incorporated herein by reference. This invention provides enhancements and improvements in such patented new technologies for extended applications of such plastic products.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A plastic board comprising symmetrical latticed ribs on both sides of said board, said latticed ribs being formed slantwise to the lengthwise direction of the board, thereby to prevent the warping of said board and reinforce its strength.

2. A plastic board comprising symmetrical latticed ribs on both sides of said board, said latticed ribs forming a continuous V-shape as continuous V-shaped ribs formed slantwise to the lengthwise direction of the board, said continuous V-shaped ribs on one side of said board being staggered lengthwise to the continuous V-shaped ribs on the other side thereby to prevent the warping of said board and reinforce its strength.

3. A plastic board comprising symmetrical latticed ribs on both sides of said board, said latticed ribs being formed slantwise to the lengthwise direction of said board, said plastic board further comprising guide channels provided for holding molten resin injected from injection molder on both sides of the board and ejecting said molten resin by pressure

4. A plastic shelf board for the display of merchandise, comprising symmetrical latticed ribs on both sides, said latticed ribs being formed slantwise to the lengthwise direction of said shelf board to prevent the warping of said shelf board and reinforce its strength.

5. The plastic shelf board as defined in claim 4, further comprising guide channels provided for holding molten resin injected from injection molder on both sides of the board and ejecting said molten resin by pressure.

6. A plastic shelf board comprising symmetrical latticed ribs on both sides of said shelf board, said latticed ribs forming a continuous V-shape as continuous V-shaped ribs formed slantwise to the lengthwise direction of said shelf board, said continuous V-shaped ribs on one side of said shelf board being staggered lengthwise to said continuous V-shaped ribs on the other side to prevent the warping of said shelf board and reinforce its strength.

7. A bracket assembly comprising a board for supporting the shelf board for the display of merchandise, a hook to connect one end to said shelf board support, a plastic bracket including symmetrical latticed ribs on both sides of said bracket, said latticed ribs being formed slantwise to the lengthwise direction of said bracket to prevent the warping of said bracket and reinforce its strength.

8. The bracket assembly as defined in claim 7, wherein the plastic bracket further include guide channels provided for holding molten resin injected from injection molder on both sides of the board and ejecting said molten resin by pressure.

9. A plastic bracket assembly comprising symmetrical latticed ribs on both sides of said bracket, moreover, said latticed ribs forming a continuous V-shape as continuous V-shaped ribs formed slantwise to the lengthwise direction of said bracket, said continuous V-shaped ribs on one side of said bracket being staggered lengthwise to the continuous V-shaped ribs on the other side to prevent the warping of said bracket and reinforce its strength.

10. The plastic bracket assembly as defined in claim 7, further comprising a hook section in a reverse L-shape for connecting one edge to said shelf board support, the inside face of said reverse L-shaped hook for contacting said catch in said support comprising a curvature.

11. The plastic bracket assembly as defined in claim 7, further comprising a hook of the shape where there is a gradually thinning taper from the top section to the bottom section of said hook.

12. A bracket assembly comprising a plastic bracket board for supporting a shelf board for the display of merchandise, a hook to connect one end to the shelf board support, wherein said plastic bracket board including symmetrical latticed ribs on both sides of said bracket, said latticed ribs being formed slantwise to the lengthwise direction of said bracket, furthermore, said bracket assembly further comprising a two-layer collar to connect by sliding into the cutout section of said shelf board support to reinforce the strength of said bracket hook.

13. A mold for molding the plastic board, comprising an injection molding mold, a top mold and a bottom mold respectively comprising concave sections for forming said board, and bottoms of said concave sections for said board being provided with latticed rib grooves slantwise to the lengthwise direction of said board thereby to prevent the warping of a molded article and reinforce its strength.

14. A mold for molding the plastic board, comprising an injection molding mold, a top mold and a bottom mold respectively comprising the concave sections for forming said board, and the bottoms of said concave sections for said board being provided with latticed rib grooves slantwise to the lengthwise direction of said board, the bottoms of said concave sections for said board provided with guide channels provided for holding molten resin injected from injection molder on both sides of the board and ejecting said molten resin by pressure

15. The mold as defined in claim 14, further comprising guide channel grooves shallower than said latticed rib grooves.

16. A method for molding a plastic board comprising symmetrically formed respective concave sections for said board and the latticed rib grooves in said top mold and said bottom mold of said injection molding mold, equal loads being exerted on said top mold and said bottom mold at the time of mold release after the injection of said molten resin, and at the same time, performing mold release operations with the same timing on said top mold and said bottom mold.

17. A showcase or display shelf where merchandise contained in containers such as cans and bottles, small boxes, bags, and the like are stored or displayed, a display shelf unit with partition boards comprising: (1) partition boards for partitioning displayed merchandise; (2) ribs with mesh structure constituting a part of said partition boards; (3) a frame part formed to enclose said ribs with mesh structure.

18. A shelf board or bottom board used in cases, heated storage units, or refrigerators and the like, where beverages in containers such as cans and bottles are stored and removed, a slide board for containers and the like comprising: (1) a flat board for placing containers such as cans, bottles, and the like; (2) a plurality of protruding ribs provided on at least one face of said flat board; (3) said plurality of protruding ribs constituting a first rib group arranged parallel to each other in one lengthwise direction and a second rib group intersecting said first rib group.
